(19) United States
(12) Patent Application Publication
(10) Pub. No.: US 2010/0325793 A1
(43) Pub. Date: Dec. 30, 2010

(54) EXAMINATION BED MOVEMENT DEVICE

(76) Inventor: Jian Liu, Shanghai (CN)

Correspondence Address: BRINKS HOFER GILSON & LIONE, P.O. BOX 10395, CHICAGO, IL, 60610, US

(21) Appl. No.: 12/823,799

(22) Filed: Jun. 25, 2010

(30) Foreign Application Priority Data
Jun. 30, 2009 (CN) 200920163228.7

(51) Int. Cl. A61G 7/10

(52) U.S. Cl. 5/81.1 C

(57) ABSTRACT

An examination bed horizontal movement device including an examination bed, an examination bed connector fixed at the bottom of the examination bed, a support board and a fixed board is provided. Two tension wheels are installed at the front and back ends of the support board separately, and the two tension wheels are connected by an examination bed conveyor belt. A tension wheel and a driving wheel are fixed at both ends of the fixed board, and the tension wheel and the driving wheel are connected by a support board conveyor belt. A driving wheel is installed coaxially on the fixed board tension wheel, and the examination bed conveyor belt winds around the driving wheel. The movement device achieves a compact design of the horizontal structure for the examination bed in a strong magnetic field MRI system and provides long travel and highly repeatable positioning accuracy of the horizontal movement.

This application claims the benefit of CN 200920163228.7, filed Jun. 30, 2009, which is hereby incorporated by reference.

### BACKGROUND

The present embodiments relate to an examination bed movement device.

A whole body scanning function may be used for advanced MR systems or CT systems. For the whole body scanning function, an examination bed has long-travel horizontal movement (e.g., may reach 2800 mm), so that the whole body scanning and imaging can be completed by having the person to be examined lie on the examination bed in one posture.

However, the horizontal movement of the examination bed is limited by the structure of the examination bed. In order to allow long horizontal movement, a horizontal movement device may be installed on the bottom of the examination bed. In operating conditions, the horizontal movement device can move the examination bed into the inside of the magnet or CT scanning area horizontally and can bring the examination bed back to the original position after the examination is completed.

Existing examination bed horizontal movement devices may adopt a double-layer horizontal movement structure in order to increase the horizontal travel. The double-layer horizontal movement structure may have a driving support board installed under the examination bed and is respectively driven by two different motors (e.g., the support board and the examination bed are driven by two motors and two conveyor belts separately). During operation, one motor first drives the support board and the examination bed to both move a certain distance, then the other motor drives the examination bed to move horizontally inside the magnet or CT scanning area, so as to complete the maximum travel of the examination bed.

When this double-layer horizontal conveyor belt driving structure is adopted, the horizontal structure occupies the space between the examination bed and the magnet because of the height restriction of the horizontal structure. This brings about a limitation to the design of the backbone coil in the magnet, and since one of the motors moves horizontally, the homogenous level of the magnetic field is affected, leading to compromised imaging quality of the scanning.

### SUMMARY AND DESCRIPTION

The present embodiments may obviate one or more of the drawbacks or limitations in the related art. For example, in one embodiment, an examination bed horizontal movement device with a simple and compact design, long horizontal travel and highly repeatable positioning accuracy may be provided.

In one embodiment, the examination bed horizontal movement device includes an examination bed connector fixed at the bottom of an examination bed, a support board installed longitudinally along the examination bed and a fixed board installed longitudinally along the support board. A support board front-end tension wheel is installed at a front end of the support board, and a support board back-end tension wheel is installed at a back end of the support board. The front-end tension wheel and the back-end tension wheel of the support board are connected by a ring-shaped examination bed conveyor belt fixed to the examination bed connector, and a support board connector is further fixed on the support board. A fixed board front-end tension wheel is installed at a front end of the fixed board, and a fixed board back-end driving wheel is installed at a back end of the fixed board. The fixed board back-end driving wheel may be driven by a motor. The fixed board front-end tension wheel and the fixed board back-end driving wheel are connected by a ring-shaped support board conveyor belt, the support board conveyor belt being fixed to the support board connector. A driving wheel is installed coaxially on the fixed board front-end tension wheel, and the examination bed conveyor belt winds around the driving wheel.

In another embodiment of the examination bed horizontal movement device, the fixed board includes at least one guide wheel installed to press the examination bed conveyor belt against the driving wheel. In one embodiment, the fixed board includes two guide wheels, which are installed separately on the side of the driving wheel closer to the support board back-end tension wheel and the side of the driving wheel closer to the support board front-end tension wheel. The guide wheels may, for example, be eccentric wheels.

In yet another embodiment of the examination bed horizontal movement device, the support board conveyor may be, for example, a synchronous conveyor belt or chain conveyor belt. The fixed board conveyor belt may also be, for example, a synchronous conveyor belt or chain conveyor belt.

The present embodiments may be used for beds of an MR system or CT system, for example. The examination bed horizontal movement device of the present embodiments enables the design of a compact horizontal structure of an examination bed for a strong magnetic field (e.g., ≧1.5 T) MRI system or CT system and is capable of highly repeatable positioning accuracy (e.g., no more than 0.5 mm) of the horizontal movement, without limiting the design space for the magnet backbone coil. The present embodiments enable the MR system or CT system to complete the whole body scan for the patient in one posture, enhancing the comfort of the patient and the speed of the system. The space used by the tension wheel and the support board installed under the examination bed is small with a vertical height less than 25 mm, for example, without affecting the installation space of the magnet coil.

### BRIEF DESCRIPTION OF THE DRAWINGS

FIG. 1 shows a schematic diagram of the initial position of one embodiment of an examination bed horizontal movement device;

FIG. 2 shows a structural schematic diagram of one embodiment of the examination bed horizontal movement device as shown in FIG. 1; and

FIG. 3 shows a schematic diagram of one embodiment of an examination bed horizontal movement device in a working position.

### DETAILED DESCRIPTION OF THE DRAWINGS

The present embodiments are described below in conjunction with the drawings in order to further clarify the technical features, purpose and effect of the present embodiments. The same number represents the same part shown in the drawings. In order to clarify the structure and interrelation of all the components, the scale of all components in the drawings are schematic only, and do not represent the scale of the real structure.

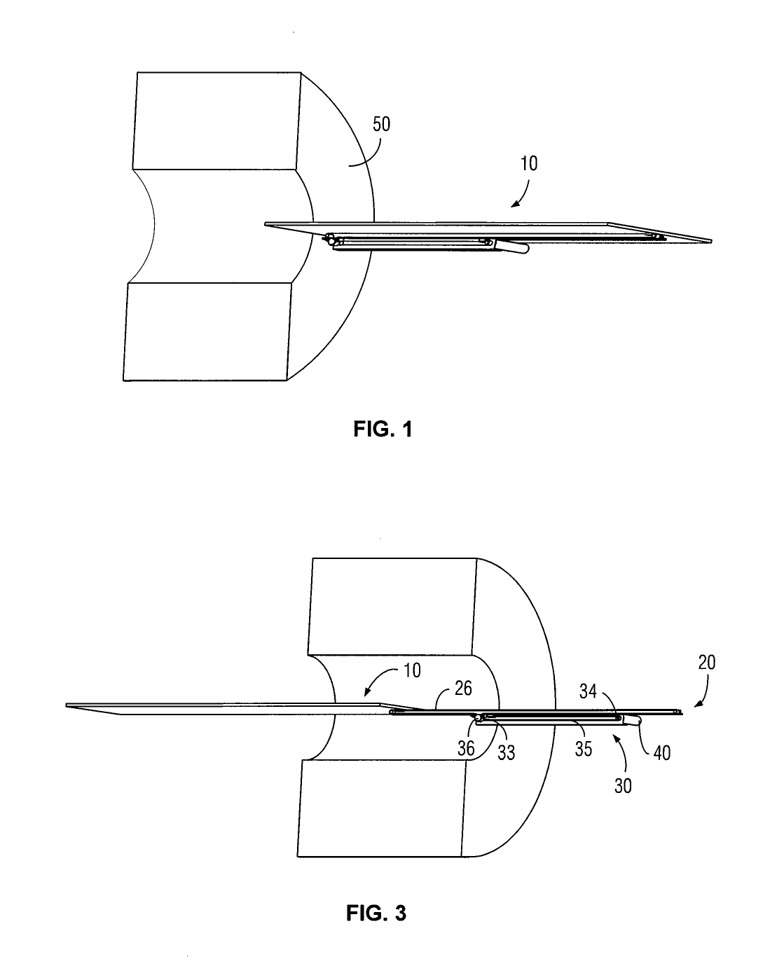

FIG. 1 shows a schematic diagram of the initial position of one embodiment of an examination bed horizontal movement device. As shown in FIG. 1, an MR system or CT system, for example, includes a magnet 50 and an examination bed 10. The subject to be examined lies on the top surface of the examination bed 10. During examination, the examination bed 10 moves horizontally, moving the part to be examined into the magnet 50. For illustration purposes, the direction that the examination bed 10 moves into the magnet 50 is the forward direction.

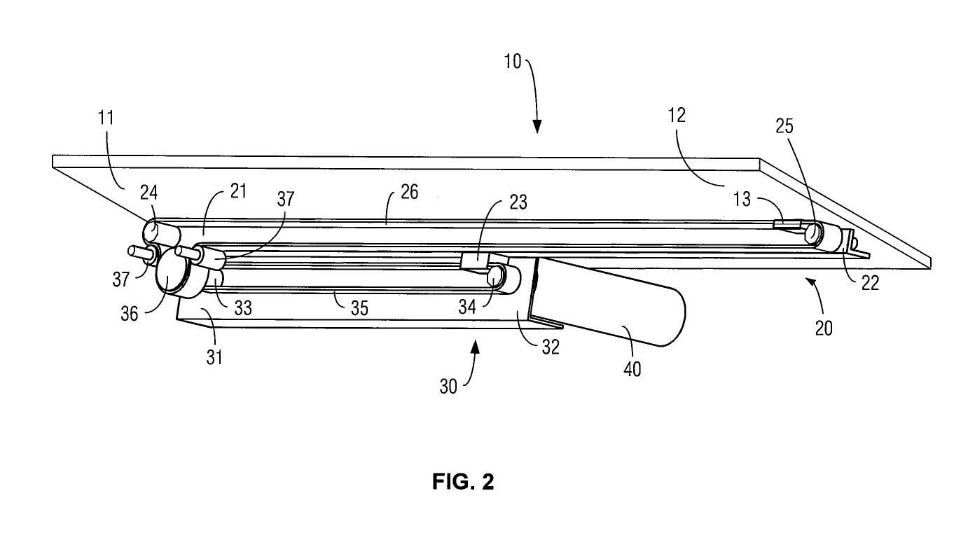

FIG. 2 shows a structural schematic diagram of one embodiment of the examination bed horizontal movement device shown in FIG. 1. As shown in FIG. 2, the examination bed 10 includes an examination bed front end 11, an examination bed back end 12 and an examination bed connector 13 fixed to the bottom of the examination bed.

The examination bed also includes a support board 20 installed longitudinally at the bottom of the examination bed 10. The forward direction of the examination bed is the forward direction of the support board 20 for clarity purposes. The support board 20 includes a support board front end 21, a support board back end 22 and a support board connector 23 fixed to the bottom of the support board 20 that is facing the examination bed 10. A support board front-end tension wheel 24 is installed at the support board front end 21. A support board back-end tension wheel 25 is installed at the support board back end 22. The support board front-end tension wheel 24 and the support board back-end tension wheel 25 are connected by a ring-shaped examination bed conveyor belt 26 fixed to the examination bed connector 13. Accordingly, when the examination bed conveyor belt 26 moves, the examination bed connector 13 may drive the examination bed 10 to move with the examination bed conveyor belt 26. In the present embodiments, the examination bed conveyor belt 26 may be any appropriate conveyor belt such as, for example, a synchronous conveyor belt or chain conveyor belt.

A fixed board 30 is installed longitudinally at the bottom of the support board 20. The forward direction of the examination bed is the forward direction of the fixed board for clarity purposes. The fixed board 30 includes a fixed board front end 31 and a fixed board back end 32. A fixed board front-end tension wheel 33 is installed at the fixed board front end 31, and a fixed board back-end driving wheel 34 is installed at the fixed board back end 32. The fixed board front-end tension wheel 33 and the fixed board back-end driving wheel 34 are connected by a ring-shaped support board conveyor belt 35 fixed to the support board connector 23. The fixed board back-end driving wheel 34 may be driven by a drive device 40 such as, for example, a motor. As shown in FIG. 2, a driving wheel 36, around which the examination bed conveyor belt 26 (e.g., synchronous examination bed conveyor belt 26) moves, is installed coaxially on the fixed board front-end tension wheel 33.

When the drive device 40 drives the fixed board back-end driving wheel 34 in rotation, the support board conveyor belt 35 drives the support board connector 23 to move with the support board conveyor belt 35. The support board 20 also moves horizontally with the support board conveyor belt 35, and the examination bed 10 is driven to move horizontally with the support board 20; at the same time, when the support board conveyor belt 35 drives the fixed board front-end tension wheel 33 in rotation, the driving wheel 36 that is coaxial with the tension wheel 33 rotates coaxially and drives the examination bed conveyor belt 26 in rotation with the driving wheel. The driving wheel 36 drives the examination bed 10 to move horizontally in relation to the support board 20 at the same time.

In order to make the operation of the examination bed conveyor belt 26 more stable and the control more accurate, a guide wheel 37 may be installed on the side of the driving wheel 36. One guide wheel 37 may be installed on the side of the driving wheel 36 closer to the support board back-end tension wheel 25, and another guide wheel 37 may be installed on the side of the driving wheel 36 closer to the support board front-end tension wheel 24, as shown in FIG. 2. Persons skilled in the art should understand that the guide wheels 37 may be installed on one side only. The guide wheel 37 is fixed on the fixed board 30, and presses the examination bed conveyor belt 26 on the driving wheel 36 tightly. In one embodiment, the guide wheel 37 may be connected by an eccentric shaft. Adjusting the eccentric shaft may tighten the conveyor belt.

As shown in FIG. 2, in the present embodiments, changing the diameter ratio of the driving wheel 36 to the fixed board front-end tension wheel 33, may accommodate different sizes of the examination bed 10, the support board 20 and the fixed board 30 in practical application, because the movement of the examination bed conveyor belt 26 is driven by the driving wheel 36 installed coaxially on the fixed board front-end tension wheel 33. Changing the diameter ratio of the fixed board back-end driving wheel 34 to the driving wheel 36, may accommodate different sizes of horizontal movement structure and meet different horizontal movement requirements, and is very flexible for installation and use.

FIG. 3 shows a schematic diagram of one embodiment of an examination bed horizontal movement device in a working position. The examination bed 10 moves into the magnet 50 to carry out examination. The long-travel horizontal movement of the examination bed 10 may be realized because the whole travel of the examination bed 10 is determined jointly by the travel of the examination bed 10 and the travel of the support board 20.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An examination bed horizontal movement device comprising:
an examination bed connector fixed at the bottom of an examination bed;
a support board installed longitudinally along the examination bed, the support board comprising:
a front-end tension wheel installed at a front end of the support board; and
a back-end tension wheel installed at a back end of the support board;
a support board connector fixed on the support board;
a fixed board installed longitudinally along the support board, the fixed board comprising:
a front-end tension wheel installed at a front end of the fixed board; and
a back-end driving wheel installed at a back end of the fixed board; and
a driving wheel installed coaxially on the front-end tension wheel of the fixed board, a ring-shaped examination bed conveyor belt, fixed to the examination bed connector, winding around the driving wheel,
wherein the front-end tension wheel and the back-end tension wheel of the support board are connected by the examination bed conveyor belt, and
wherein the front-end tension wheel and the back-end driving wheel of the fixed board are connected by a ring-shaped support board conveyor belt, the support board conveyor belt being fixed to the support board connector.

2. The examination bed horizontal movement device as claimed in claim 1, wherein the fixed board further comprises a guide wheel to press the examination bed conveyor belt against the driving wheel.

3. The examination bed horizontal movement device as claimed in claim 2, wherein the fixed board further comprises another guide wheel, the guide wheel being installed on a side of the driving wheel closer to the back-end tension wheel of the support board and another guide wheel being installed on a side of the driving wheel closer to the front-end tension wheel of the support board.

4. The examination bed horizontal movement device as claimed in claim 2, wherein the guide wheel is an eccentric wheel.

5. The examination bed horizontal movement device as claimed in claim 1, wherein the support board conveyor belt is a synchronous conveyor belt.

6. The examination bed horizontal movement device as claimed in claim 1, wherein the support board conveyor belt is a chain conveyor belt.

7. The examination bed horizontal movement device as claimed in claim 1, wherein the examination bed conveyor belt is a synchronous conveyor belt.

8. The examination bed horizontal movement device as claimed in claim 1, wherein the examination bed conveyor belt is a chain conveyor belt.

9. The examination bed horizontal movement device as claimed in claim 3, wherein the guide wheel and the another guide wheel are eccentric wheels.
